(19) United States
(12) Patent Application Publication
(10) Pub. No.: US 2022/0055289 A1
(43) Pub. Date: Feb. 24, 2022

(54) APPARATUS AND METHOD IN 3D PRINTING

(71) Applicant: Lung Biotechnology PBC, Silver Spring, MD (US)

(72) Inventors: Mohammadali Safavieh, Nashua, NH (US); Daniel E. Backman, Bedford, NH (US); Kalyan Vydiam, Manchester, NH (US); Masoud Modaresifar, Manchester, NH (US); Lara A. Murcin, Stratham, NH (US); Luis Alvarez, Lexington, MA (US); Derek Morris, Somerville, MA (US); Akarsh Sivaprasad, Nashua, NH (US)

(73) Assignee: Lung Biotechnology PBC, Silver Spring, MD (US)

(21) Appl. No.: 17/410,159

(22) Filed: Aug. 24, 2021

Related U.S. Application Data
(60) Provisional application No. 63/069,317, filed on Aug. 24, 2020.

(51) Int. Cl. B29C 64/124; B29C 64/245; B29C 64/321; B33Y 10/00; B33Y 30/00; B33Y 40/00; B33Y 70/00; B33Y 80/00

(52) U.S. Cl. CPC B29C 64/124; B29C 64/245; B29C 64/321; B33Y 10/00; B29L 2031/7532; B33Y 40/00; B33Y 70/00; B33Y 80/00; B29K 2995/0059; B33Y 30/00

(57) ABSTRACT

Apparatus and method for forming a three-dimensional object. The apparatus includes a platform on which the three-dimensional object is formed. The apparatus includes an oxygen soluble liquid having a build surface. The build surface and the platform define a build region therebetween. The apparatus includes a photosensitive liquid disposed on the oxygen soluble liquid. The density of the oxygen soluble liquid is greater than the density of the photosensitive liquid. The apparatus includes an optically transparent member. The optically transparent member supports the oxygen soluble liquid. The apparatus includes a radiation source configured to irradiate the build region through the optically transparent member and the oxygen soluble liquid to form a solid polymer from the photosensitive liquid. The apparatus includes a controller configured to advance the platform away from the build surface.

### CROSS-REFERENCE TO RELATED APPLICATIONS

This application claims priority to U.S. Provisional Application No. 63/069,317, filed Aug. 24, 2020, the entire contents of which are incorporated herein.

### TECHNICAL FIELD

The present application relates to processes to eliminate or improve the large membrane deformation of oxygen permeable membranes in 3D printing applications.

### BACKGROUND

Oxygen permeable membranes can be used in 3D top-down projecting printing applications.

### SUMMARY

The systems and methods of the present disclosure can address issues related to membrane deformation of an oxygen permeable membrane with ink in a three-dimensional (3D) top-down projecting printing process. The systems and methods of the present disclosure can enable the use of continuous 3D printing without the need of an oxygen permeable membrane. In addition, the systems and methods of the present disclosure can resolve the problem of membrane deformation for printing over large areas, which can be used for printing large objects with high resolution.

At least one aspect of the present disclosure is directed to an apparatus for forming a three-dimensional object. The apparatus includes a platform on which the three-dimensional object is formed. The apparatus includes an oxygen soluble liquid having a build surface. The build surface and the platform define a build region therebetween. The apparatus includes a photosensitive liquid disposed on the oxygen soluble liquid. A density of the oxygen soluble liquid is greater than a density of the photosensitive liquid. The apparatus includes an optically transparent member. The optically transparent member supports the oxygen soluble liquid. The apparatus includes a radiation source configured to irradiate the build region through the optically transparent member and the oxygen soluble liquid to form a solid polymer from the photosensitive liquid. The apparatus includes a controller configured to advance the platform away from the build surface.

Another aspect of the present disclosure is directed to an apparatus for forming a three-dimensional object. The apparatus includes a platform on which the three-dimensional object is formed. The apparatus includes an oxygen permeable membrane having a build surface. The build surface and the platform define a build region therebetween. The apparatus includes a photosensitive liquid disposed on the oxygen permeable membrane. The apparatus includes an oxygen soluble liquid. The oxygen soluble liquid supports the oxygen permeable membrane. A density of the oxygen soluble liquid is greater than a density of the photosensitive liquid. The apparatus includes an optically transparent member. The optically transparent member supports the oxygen soluble liquid. The apparatus includes a radiation source configured to irradiate the build region through the optically transparent member, the oxygen soluble liquid, and the oxygen permeable membrane to form a solid polymer from the photosensitive liquid. The apparatus includes a controller configured to advance the platform away from the build surface.

Another aspect of the present disclosure is directed to a method for forming a three-dimensional object. The method includes providing a platform and an oxygen soluble liquid having a build surface. The build surface and the platform define a build region therebetween. The method includes disposing a photosensitive liquid on the oxygen soluble liquid. A density of the oxygen soluble liquid is greater than a density of the photosensitive liquid. The method includes supporting the oxygen soluble liquid on an optically transparent member. The method includes irradiating the build region through the optically transparent member and the oxygen soluble liquid to form a solid polymer from the photosensitive liquid. The method includes advancing the platform away from the build surface.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 illustrates a perfluorodecalin and ink interface, according to an embodiment.

FIG. 2 illustrates the contact angle of water and perfluorodecalin on an AF2400 membrane, according to an embodiment.

FIG. 3 illustrates an absorption spectra of perfluorodecalin, according to an embodiment.

FIG. 4 illustrates a plot of refractive indices for perfluorodecalin, water, and air, according to an embodiment.

FIG. 5 illustrates a schematic of an inverted digital light projection (DLP) system without a solid membrane interface, according to an embodiment.

FIG. 6 illustrates a detailed view of an X-Z cross-sectional area of the platform in FIG. 5, according to an embodiment.

FIG. 7 illustrates a schematic of a non-compressible oxygen carrier liquid, according to an embodiment.

FIG. 8 illustrates a schematic of membrane deformation under hydrostatic pressure, according to an embodiment.

FIG. 9 illustrates deformation of an AF2400 membrane, according to an embodiment.

FIG. 10 illustrates membrane deformation across the dotted line depicted in FIG. 9 with respect to different hydrostatic pressure loaded on the membrane, according to an embodiment.

FIG. 11 illustrates a plot of normalized deformation vs. hydrostatic pressure, according to an embodiment.

Like reference numbers and designations in the various drawings indicate like elements.

### DETAILED DESCRIPTION

The oxygen inhibition layer (e.g., dead zone) can control printing cure layer thickness in 3D printing applications. Solid membrane interfaces (e.g., AF2400) with high oxygen permeability can be used to control the inhibition of the photo-polymerization. These solid membrane interfaces can be chemically inert and UV transparent. However, these oxygen permeable membranes can have problems when 3D printing over large cross-sectional areas at a high resolution. When printing with high UV intensities, dead zone thickness can decrease and cause window adhesion defects. The window adhesion defects can inhibit the free motion of the printing object. The 3D printed object can collapse and fall into the vat before the printing process is completed. In addition, when printing with large ink volumes, the hydrostatic pressure of the ink can cause significant vertical membrane deflection and can move the plane of polymerization off the projector's focal plane. This can cause the object to get printed at lower power intensity and lower resolution. Therefore, there is a need for process improvements for 3D objects with large cross-sectional areas while maintaining high resolution.

Rapid, high precision additive manufacturing (AM) can be important in organ manufacturing and 3D scaffold printing. Three-dimensional printing can materialize a computer aided design (CAD) virtual 3D model by slicing the CAD model and photopolymerizing an object layer-by-layer. Stereolithography (SL) techniques can be used as a platform where the exposure of UV laser rasterizing takes place in a top-down manner. Digital light projection (DLP) can eliminate laser rasterizing and can allow the photopolymerization of UV curable polymer to take place at a single exposure, in a bottom-up manner. In all these techniques, the photopolymerization can be inhibited by atmospheric oxygen. Oxygen inhibition can occur at the build window and result in the formation of a dead zone. The dead zone can include a location where oxygen inhibition dominates and no photopolymerization reaction takes place. For the ambient air below the window, dead zone can be calculated by Equation 1:

$$D Z = {C ( \frac{{Φ}_{0} {α}_{PI + Ab}}{{D}_{e}} )}^{- 0.5} \qquad Eq . ( 1 )$$

where C is the proportional value, Φ₀ is the number of photon flux per area per time, α_{PI+Ab} is the absorbance peak of photo-initiator and absorber and Dₑ denotes the monomer reactivity with photo initiator. Increasing Φ₀ or α_{PI+Ab} can decrease the oxygen concentration. At dead zone thicknesses between 20 μm to 30 μm, the dead zone can be so negligible that the cross-linked polymer can adhere to the membrane and yield to a defect or cause the print object to fail.

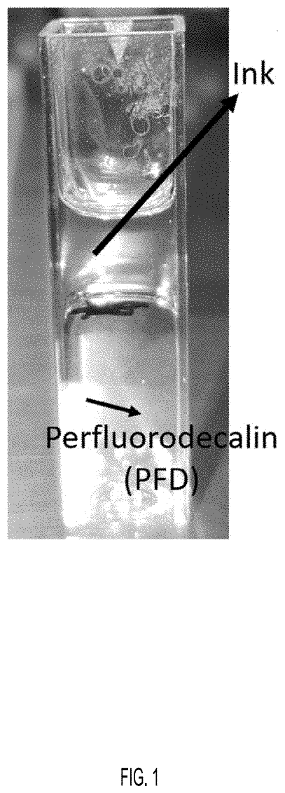

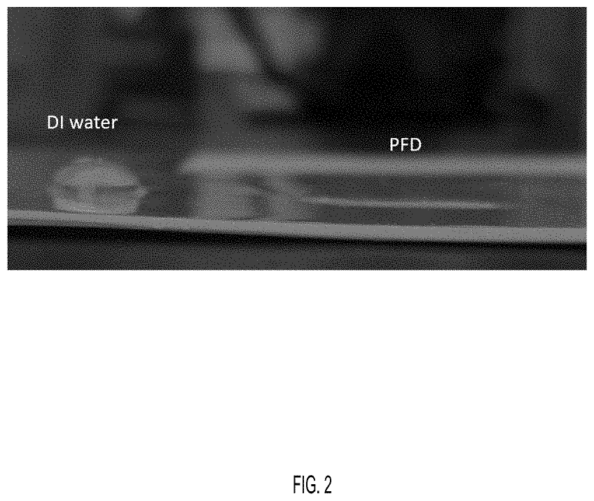

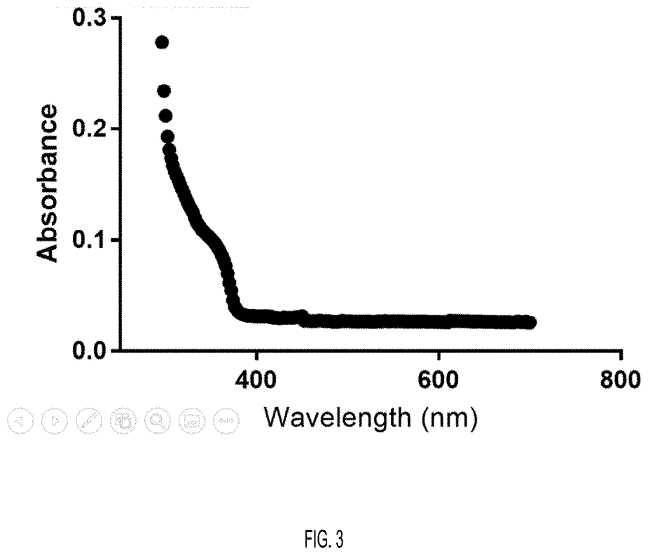

To overcome the adherence defects caused by small dead-zone thickness, the oxygen permeable membrane can be replaced with an oxygen soluble liquid (e.g., oxygen carrier liquid) with higher density than bio-ink. The oxygen soluble liquid can include Perfluorodecalin (PFD) (C₁₀F₁₈), an oxygen soluble liquid with density of 1.917 g/cm³ and an oxygen solubility 40.5 ml O₂/100 ml of fluid. FIG. 1 illustrates a PFD and ink interface. The high density of PFD can make this oxygen carrier liquid very robust to create two phase system (e.g., for water soluble inks). FIG. 2 illustrates the contact angle of water and PFD on an AF2400 membrane. In addition, PFD has a robust wettability to AF2400 membrane which yields improvement of PFD and AF2400 adherence. FIG. 3 illustrates an absorption spectra of PFD. The absorbance of PFD at 365 nm and 405 nm are 0.07 and 0.03, respectively. PFD can be used as an alternative for a solid oxygen permeable membrane.

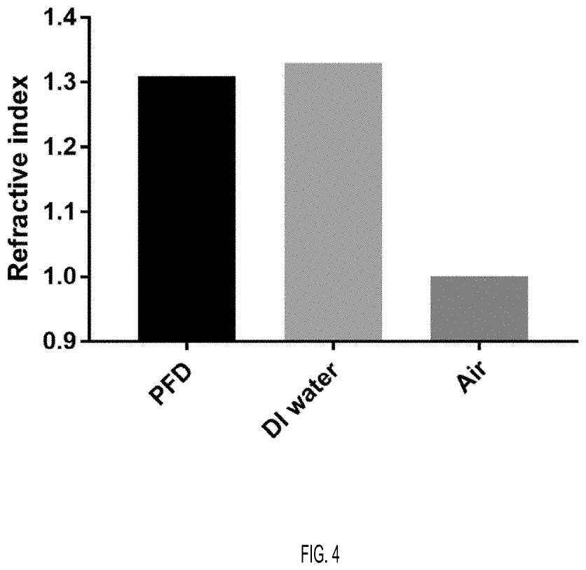

FIG. 4 illustrates a plot of refractive indices for perfluorodecalin, water, and air. Due to having high refractive index (1.36) relative to air, the projected image may require modification to compensate the amount by which the object gets smaller. The refractive index of PFD can be between 1.3 and 1.4. The refractive index of water (e.g., deionized water, DI water, etc.), can be between 1.3 and 1.4. The refractive index of air can be approximately 1. The refractive indices can be measured at standard temperature and pressure.

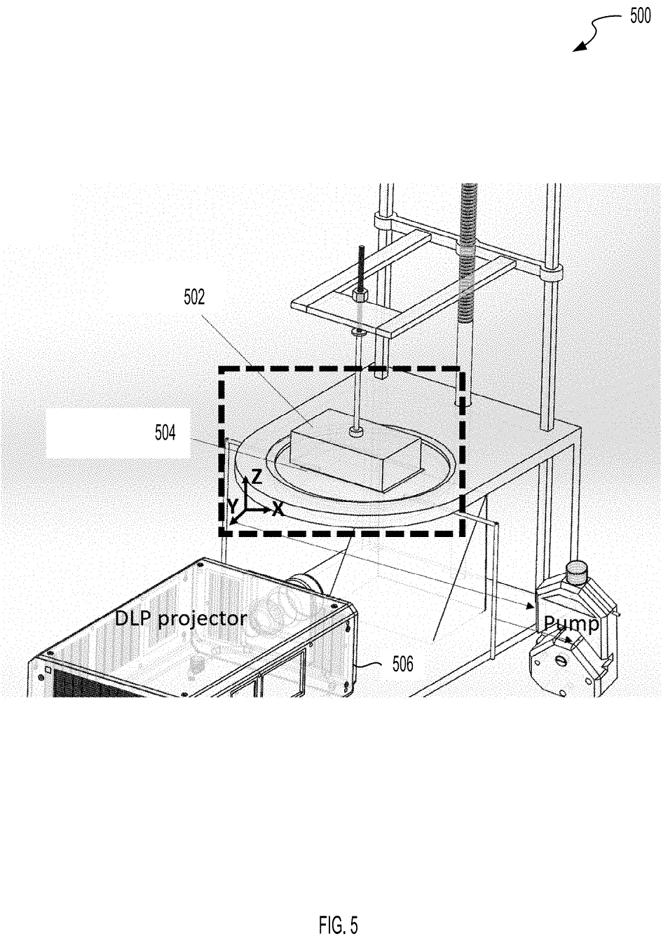

FIG. 5 illustrates a schematic of an inverted digital light projection (DLP) system 500 without a solid membrane interface. Oxygen carrier liquids can be used with or without a solid membrane in the polymerization vat. As an alternative to using a solid membrane with an inverted DLP 3D-printer, a Volumetric™ 3D printer can be modified by removing the membrane at the bottom and replacing it with a high density oxygen carrier liquid. High density oxygen carrier liquids can be circulated using a peristaltic pump at the flow rate of 10 μL/min to keep the oxygen concentration of the oxygen constant during printing.

The system 500 for forming a three-dimensional object can include a platform 502 (e.g., print platform) on which the three-dimensional object is formed. The three-dimensional object can include an artificial organ (e.g., artificial lung, artificial heart, artificial kidney, artificial liver, etc.). The system 500 can include an oxygen soluble liquid 604 (e.g., oxygen carrier liquid) having a build surface. The oxygen soluble liquid 604 can include a fluorocarbon material such as perfluorodecalin or Krytox fluorinated oil. The oxygen soluble liquid 604 can have an oxygen solubility of greater than 0.3 ml O₂/ml oxygen soluble liquid. For example, the oxygen soluble liquid 604 can have an oxygen solubility of 0.4 ml O₂/ml oxygen soluble liquid, 0.5 ml O₂/ml oxygen soluble liquid, or 0.6 ml O₂/ml oxygen soluble liquid.

The build surface and the platform 502 can define a build region 504 (e.g., build window) therebetween. The system 500 can include a controller configured to advance the platform 502 away from the build surface. For example, the controller can lower or raise the platform 502. The controller can be configured to maintain an oxygen inhibition layer thickness of at least 20 μm. For example, the controller can maintain an oxygen inhibition layer thickness of 20 μm, 25 μm, 30 μm, 35 μm, 40 μm, 45 μm, or 50 μm.

The system 500 can include a radiation source 506 (e.g., DLP projector, projector, illumination source, etc.) configured to irradiate the build region 504. The radiation source 506 can be configured to irradiate the build region 504 through an optically transparent member and the oxygen soluble liquid 604 to form a solid polymer from a photosensitive liquid (e.g., photosensitive resin, ink, etc.). In some embodiments, the system 500 can include a peristaltic pump (e.g., pump) to recirculate the oxygen soluble liquid 604. The peristaltic pump can include a positive displacement pump used to pump the oxygen soluble liquid 604.

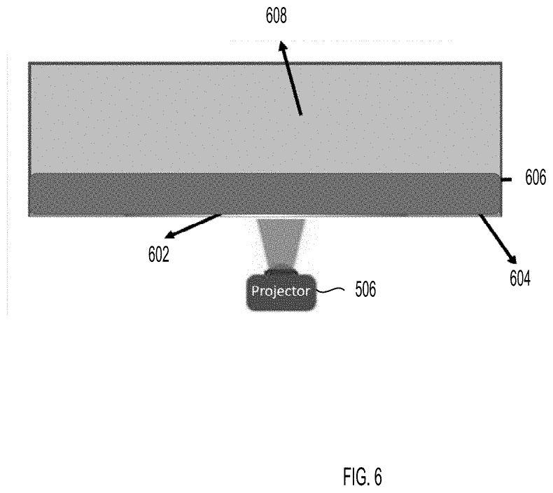

FIG. 6 illustrates a detailed view of an X-Z cross-sectional area of the platform 502 in FIG. 5. The platform 502 can include a transparent glass 602 (e.g., optically transparent glass, optically transparent member, etc.). For example, the transparent glass 602 can support the oxygen soluble liquid 604. The oxygen soluble liquid 604 can be disposed on the transparent glass 602. The thickness of the transparent glass 602 can be substantially less than the thickness of the oxygen soluble liquid 604.

The platform 502 can include a high density oxygen carrier liquid (e.g., non-compressible oxygen carrier liquid) on the transparent glass 602. The platform 502 can include an ink 608 (e.g., photosensitive ink, photosensitive liquid, etc.). The photosensitive liquid can be disposed on the oxygen soluble liquid 604. The oxygen soluble liquid 604 can be located below the ink 608. The density of the oxygen soluble liquid 604 can be greater than a density of the photosensitive liquid. The platform 502 can include an interface 606 between oxygen carrier liquid and photosensitive ink (e.g., an ink and PFD interface). The thickness of the ink 608 can be greater than the thickness of the oxygen soluble liquid 604. The thickness of the ink 608 can be substantially greater than the thickness of the transparent glass 602.

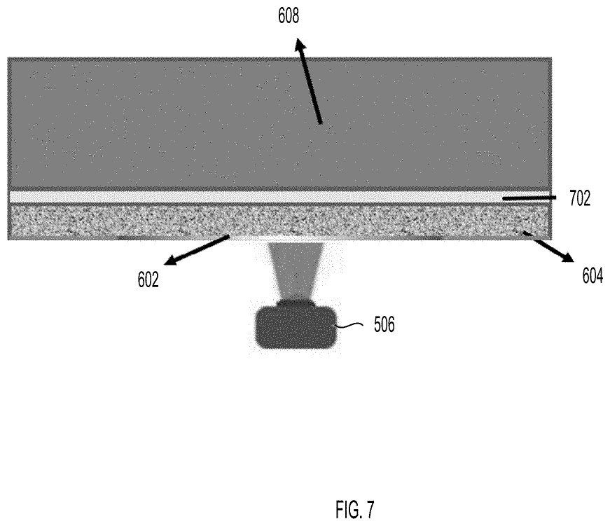

FIG. 7 illustrates a schematic of a non-compressible oxygen carrier liquid. The non-compressible oxygen carrier liquid can be used for support of the oxygen permeable liquid. The platform 502 can include the transparent glass 602 (e.g., optically transparent glass, optically transparent member, etc.). The platform 502 can include the non-compressible oxygen soluble liquid 604 (e.g., oxygen carrier liquid). The optically transparent member can support the oxygen soluble liquid 604.

The platform 502 can include an oxygen permeable membrane 702. The oxygen permeable membrane 702 can include a polytetrafluoroethylene membrane. The oxygen permeable membrane 702 can have an oxygen permeability of greater than 1600×10⁻¹⁰ cm³ (STP) cm/(cm² s cm Hg). The oxygen permeable membrane 702 can have a build surface. The build surface and the platform 502 can the build region 504 therebetween. The oxygen soluble liquid 604 can support the oxygen permeable membrane 702. The density of the oxygen soluble liquid 604 can be greater than a density of the photosensitive liquid. The thickness of the oxygen permeable membrane 702 can be less than the thickness of the oxygen soluble liquid 604.

The platform 502 can include the ink 608 (e.g., photosensitive ink). The photosensitive liquid can be disposed on the oxygen permeable membrane 702. The platform can include the radiation source 506. The radiation source 506 can be configured to irradiate the build region 504 through an optically transparent member, the oxygen soluble liquid 604, and the oxygen permeable membrane 702 to form a solid polymer from a photosensitive liquid. The thickness of the oxygen soluble liquid 604 can be less than the thickness of the ink 608.

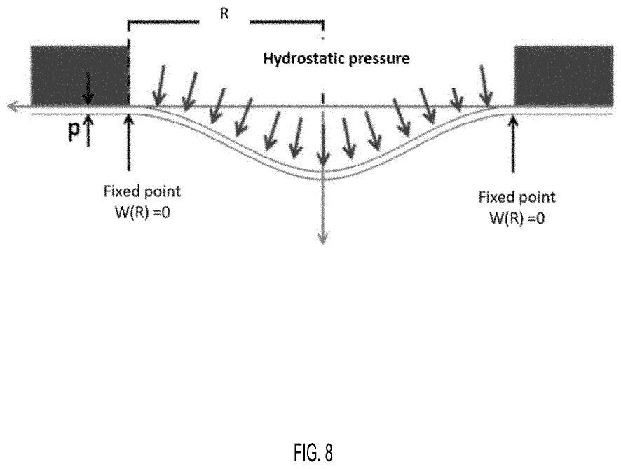

To allow enough oxygen transport to maintain an ideal dead zone thickness, highly oxygen permeable membranes, such as AF2400, may be very thin. When loaded with large volumes of ink, the thin membranes can experience high deformation. This problem may worsen when printing over a large cross-sectional areas. FIG. 8 illustrates a schematic of membrane deformation under hydrostatic pressure. The amount of deformation can be large enough in some cases that the projected image is off the focal plane of the projector. The deformation problem can be described by two nonlinear differential equations:

$$\begin{matrix}\frac{{d}^{2} u}{d {r}^{2}} + \frac{1}{r} \frac{d u}{d r} - \frac{u}{{r}^{2}} = - \frac{1 - v}{2 r} {( \frac{d w}{d r} )}^{2} - \frac{d w}{d r} \frac{{d}^{2} w}{d {r}^{2}} & Eq . ( 2 ) \\ \frac{{d}^{3} w}{d {r}^{3}} + \frac{1}{r} \frac{{d}^{2} w}{d {r}^{2}} - \frac{1}{{r}^{2}} \frac{d w}{d r} = - \frac{12}{{d}^{2}} \frac{d w}{d r} [ \frac{d u}{d r} + \frac{vu}{r} + \frac{1}{2} {( \frac{d w}{d r} )}^{2} + \frac{p r}{2 F} ] & Eq . ( 3 )\end{matrix}$$

where u(r) and w(r) are displacement in radial and axial direction or r and z respectively, d is the thickness of membrane, p is the uniform hydrostatic pressure and F is the function of elasticity, Young modulus, and Poisson ratio. The boundary conditions can be defined as:

$$\begin{matrix}u = \frac{d W}{d r} = 0 , at r = 0 & Eq . ( 4 ) \\ u = w = \frac{d W}{d r} = 0 at r = R & Eq . ( 5 )\end{matrix}$$

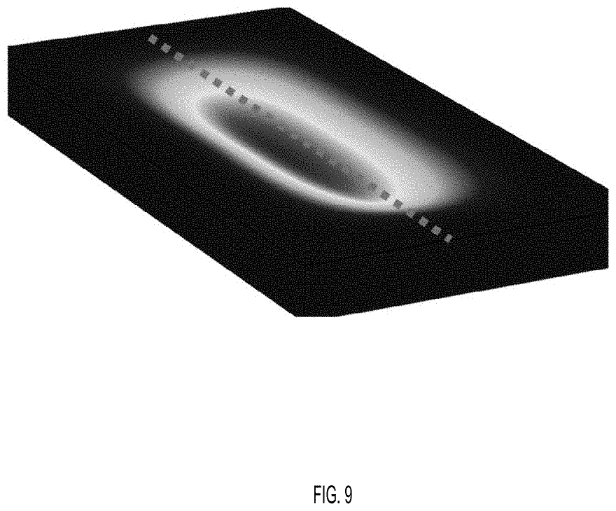

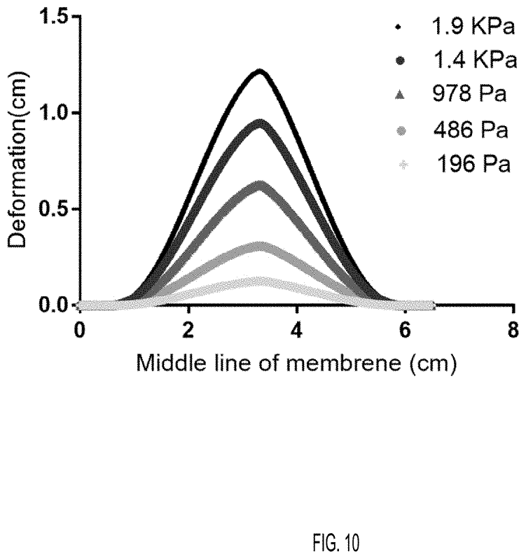

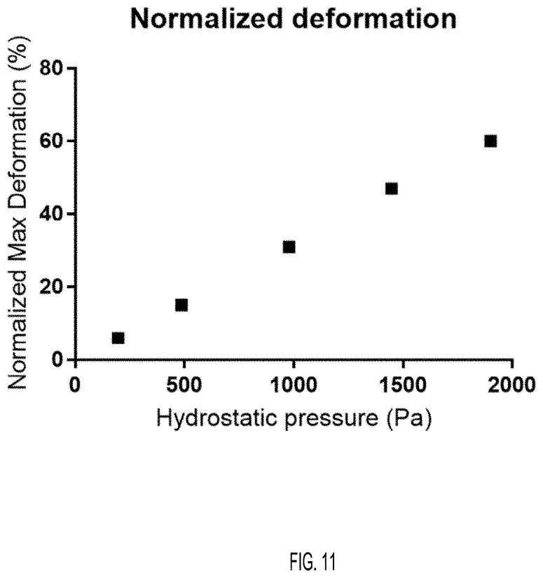

FIG. 9 illustrates deformation of an AF2400 membrane. Using COMSOL Multiphysics 5.4, maximum deformation (cm) across the membrane can be calculated. FIG. 10 illustrates membrane deformation across the dotted line depicted in FIG. 9 with respect to different hydrostatic pressure loaded on the membrane Deformation of the membrane can be evaluated across the line at the center of the membrane varying hydrostatic pressure due to loading different amount of ink in the vat. The normalized value of the deformation in the middle of the membrane can be up to 60% compared with the height of the membrane platform. To avoid this problem, the membrane can include a robust and strong support from underneath. Oxygen carrier liquids having high density and strong wettability on AF2400 can be used as the source of oxygen with an oxygen permeable membrane. FIG. 11 illustrates a plot of normalized deformation (%) vs. hydrostatic pressure (Pa). As hydrostatic pressure increases, normalized max deformation increases.

A method for forming a three-dimensional object (e.g., article) can include providing a platform and an oxygen soluble liquid having a build surface. The build surface and the platform can define a build region therebetween. The method can include disposing a photosensitive liquid on the oxygen soluble liquid. The density of the oxygen soluble liquid can be greater than the density of the photosensitive liquid. The method can include supporting the oxygen soluble liquid on an optically transparent member. The method can include irradiating the build region through the optically transparent member and the oxygen soluble liquid to form a solid polymer from the photosensitive liquid. The method can include advancing the platform away from the build surface.

In some embodiments, the method can include providing an oxygen permeable membrane disposed between the photosensitive liquid and the oxygen soluble liquid. In some embodiments, the method can include maintaining an oxygen inhibition layer thickness of at least 20 μm. In some embodiments, the method can include recirculating, using a peristaltic pump, the oxygen soluble liquid. In some embodiments, the oxygen soluble liquid is a fluorocarbon material such as perfluorodecalin or Krytox fluorinated oil. In some embodiments, the three-dimensional object is an artificial organ (e.g., artificial lung, artificial heart, artificial kidney, artificial liver, etc.).

Any references to implementations or elements or acts of the systems and methods herein referred to in the singular can include implementations including a plurality of these elements, and any references in plural to any implementation or element or act herein can include implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

Any implementation disclosed herein may be combined with any other implementation, and references to “an implementation,” “some implementations,” “an alternate implementation,” “various implementations,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Elements other than ‘A’ and ‘B’ can also be included.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

The systems and methods described herein may be embodied in other specific forms without departing from the characteristics thereof. The foregoing implementations are illustrative rather than limiting of the described systems and methods.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. An apparatus for forming a three-dimensional object, comprising:
a platform on which the three-dimensional object is formed;
an oxygen soluble liquid having a build surface, the build surface and the platform defining a build region therebetween;
a photosensitive liquid disposed on the oxygen soluble liquid, wherein a density of the oxygen soluble liquid is greater than a density of the photosensitive liquid;
an optically transparent member configured to support the oxygen soluble liquid;
a radiation source configured to irradiate the build region through the optically transparent member and the oxygen soluble liquid to form a solid polymer from the photosensitive liquid; and
a controller configured to advance the platform away from the build surface.

2. The apparatus of claim 1, further comprising:
a peristaltic pump to recirculate the oxygen soluble liquid.

3. The apparatus of claim 1, wherein the oxygen soluble liquid is a fluorocarbon material.

4. The apparatus of claim 1, wherein the oxygen soluble liquid has an oxygen solubility of greater than 0.3 ml O₂/ml oxygen soluble liquid.

5. The apparatus of claim 1, wherein the three-dimensional object is an artificial organ.

6. An apparatus for forming a three-dimensional object, comprising:
a platform on which the three-dimensional object is formed;
an oxygen permeable membrane having a build surface, the build surface and the platform defining a build region therebetween;
a photosensitive liquid disposed on the oxygen permeable membrane;
an oxygen soluble liquid, the oxygen soluble liquid to support the oxygen permeable membrane, wherein a density of the oxygen soluble liquid is greater than a density of the photosensitive liquid;
an optically transparent member, the optically transparent member to support the oxygen soluble liquid;
a radiation source configured to irradiate the build region through the optically transparent member, the oxygen soluble liquid, and the oxygen permeable membrane to form a solid polymer from the photosensitive liquid; and
a controller configured to advance the platform away from the build surface.

7. The apparatus of claim 6, further comprising:
a peristaltic pump to recirculate the oxygen soluble liquid.

8. The apparatus of claim 6, wherein the oxygen soluble liquid is at least one of perfluorodecalin, Krytox fluorinated oil, or Solvay Fomblin Y.

9. The apparatus of claim 6, wherein the oxygen soluble liquid has an oxygen solubility of greater than 0.3 ml O₂/ml oxygen soluble liquid.

10. The apparatus of claim 6, wherein the three-dimensional object is an artificial organ.

11. The apparatus of claim 6, wherein the oxygen permeable membrane is a polytetrafluoroethylene membrane.

12. The apparatus of claim 6, wherein the oxygen permeable membrane has an oxygen permeability of greater than 1600×10⁻¹⁰ cm³ (STP) cm/(cm² s cm Hg).

13. The apparatus of claim 6, wherein the controller is configured to maintain an oxygen inhibition layer thickness of at least 20 μm.

14. A method for forming a three-dimensional object, comprising:
providing a platform and an oxygen soluble liquid having a build surface, the build surface and the platform defining a build region therebetween;
disposing a photosensitive liquid on the oxygen soluble liquid, wherein a density of the oxygen soluble liquid is greater than a density of the photosensitive liquid;
supporting the oxygen soluble liquid on an optically transparent member;
irradiating the build region through the optically transparent member and the oxygen soluble liquid to form a solid polymer from the photosensitive liquid; and
advancing the platform away from the build surface.

15. The method of claim 14, further comprising:
providing an oxygen permeable membrane disposed between the photosensitive liquid and the oxygen soluble liquid.

16. The method of claim 14, further comprising:
maintaining an oxygen inhibition layer thickness of at least 20 μm.

17. The method of claim 14, further comprising:
recirculating, using a peristaltic pump, the oxygen soluble liquid.

18. The method of claim 14, wherein the oxygen soluble liquid is a fluorocarbon material.

19. The method of claim 14, wherein the three-dimensional object is an artificial organ.

20. An article comprising the three-dimensional object produced by the method of claim 14.
